(19) United States
(12) Patent Application Publication
(10) Pub. No.: US 2005/0261024 A1
(43) Pub. Date: Nov. 24, 2005

(54) Apparatus and method for processing voice in mobile communication terminal

(75) Inventor: Jong Sung Jin, Seoul (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: PANTECH CO., LTD.

(21) Appl. No.: 11/024,287

(22) Filed: Dec. 28, 2004

(30) Foreign Application Priority Data
May 18, 2004 (KR) 10-2004-0035343

(51) Int. Cl. H04B 1/38

(52) U.S. Cl. 455/557

(57) ABSTRACT

Disclosed are an apparatus and a method for processing voice in a mobile communication terminal, which may prevent howling and echo between a microphone and a receiver of the mobile communication terminal. The apparatus comprises: a main chip for controlling an audio codec; a microphone; a receiver; a handsfree for performing functions of inputting and outputting the voice; an earphone jack for connecting the handsfree to the audio codec; a hall IC for generating folder on/off detecting signal by sensing whether the folder of the mobile communication terminal is opened or closed; and a switch, located in between the microphone and the audio codec, for connecting the microphone and the audio codec based on the folder on/off detecting signal generated by the hall IC and jack detecting signal indicating that the handsfree is connected to the mobile communication terminal.

### CROSS-REFERENCE TO RELATED APPLICATIONS

The present application is claiming priority of Korean Patent Application No. 10-2004-0035343, filed on May 18, 2004, the content of which is incorporated herein by reference.

### BACKGROUND OF THE INVENTION

1. Field of the Invention

The present invention relates to an apparatus and a method for processing a voice in a mobile communication terminal. More particularly, the present invention relates to an apparatus and a method for processing a voice in a mobile communication terminal, which can prevent howling and echo between a microphone and a receiver of the mobile communication terminal.

2. Description of the Related Art

Generally, a mobile communication terminal has a function of allowing a user to make a call through an earphone having a microphone (i.e., a handsfree). Particularly, it is possible for a folder-type mobile communication terminal to make a call with the folder being closed, when the handsfree is connected to the mobile communication terminal.

At this time, even though the handsfree is disconnected from the mobile communication terminal while performing call connection with the folder being closed, the call connection is still maintained and microphone and receiver of the mobile communication terminal are closely located until the folder of the mobile communication terminal is opened. Thereafter, there are problems of howling and echo that user of the mobile communication terminal hears what the user just said.

As illustrated in FIG. 1, a configuration for processing a voice in a conventional mobile communication terminal comprises: a main chip 10 having a built-in audio codec 11 for processing voice signal; a microphone 12 for inputting a voice of a user; a receiver 13 for outputting a voice signal applied from the audio codec 11; a handsfree 14 having functions of microphone and receiver; an earphone jack 15 for connecting the handsfree 14 to the mobile communication terminal; and a hall IC 16 for detecting whether a folder of the mobile communication terminal is closed or opened.

The main chip 10 controls operations of all elements. Particularly, the main chip checks whether the handsfree 14 is connected or not through the earphone jack 15 by receiving a jack detecting signal from the earphone jack 15, and whether the folder of the mobile communication terminal is closed or opened by receiving a folder on/off detecting signal from the hall IC 16.

Meanwhile, in the folder-type mobile communication terminal having the above-mentioned configuration, when the folder is closed during a call connection without using the handsfree 14, the hall IC 16 detects that the folder is closed, generates a folder on/off detecting signal indicating closure of the folder and applies the generated signal to the main chip 10.

Then, the main chip 10 recognizes that the folder is closed, by receiving the folder on/off detecting signal indicating the closure of the folder applied from the hall IC 16 and simultaneously performs a call terminating operation by recovering sources set up for the call connection.

On the contrary, when the folder is closed during a call connection using the handsfree 14, the hall IC 16 detects that the folder is closed, generates a folder on/off detecting signal indicating the closure of the folder and applies the generated signal to the main chip 10.

However, since a call connection is performed by using the handsfree and the main chip 10 has already received the jack detecting signal from the earphone jack 15, the call connection is maintained regardless of the closure/openness of the folder. At this time, the call connection is maintained even though the handsfree is disconnected from the mobile communication terminal.

In other words, the call connection is not terminated until the user opens the folder and then forcibly pushes a call-terminating button or until the user opens the folder and closes the folder again, so that the call connection is continuously maintained.

Like this, according to the prior art, since the call connection is maintained even when the handsfree is pulled out during the call connection using the handsfree with the folder being closed, the howling and echo may be caused due to the close position between the microphone and the receiver unless the folder is opened.

### SUMMARY OF THE INVENTION

Accordingly, the present invention has been made to solve the above-mentioned problems occurring in the prior art. The object of the present invention is to provide an apparatus and a method for processing a voice in a mobile communication terminal which can prevent howling and echo from occurring between a microphone and a receiver of the mobile communication terminal.

To eliminate howling and echo between the microphone and the receiver, an analog switch, connected in between the microphone and the receiver, blocks voice signals of the microphone while maintaining call connection, if a folder of the mobile communication terminal is closed.

In order to accomplish these objects, there is provided an apparatus for processing a voice in a mobile communication terminal comprising: a main chip for controlling an audio codec; a microphone for inputting a voice signal to the audio codec; a receiver for outputting the voice signal processed by the audio codec; a handsfree for performing functions of inputting and outputting the voice; an earphone jack for connecting the handsfree to the audio codec; a hall IC for generating folder on/off detecting signal by sensing whether the folder of the mobile communication terminal is opened or closed; and a switch, located in between the microphone and the audio codec, for connecting the microphone and the audio codec based on the folder on/off detecting signal generated by the hall IC and jack detecting signal indicating that the handsfree is connected to the mobile communication terminal.

Preferably, the switch may disconnect the microphone and the audio codec upon receiving the jack detecting signal.

Preferably, the switch may maintain disconnection between the microphone and the audio codec without the jack detecting signal, while receiving the folder on/off detecting signal indicating closure of the folder.

Preferably, the switch may reconnect the microphone and the audio codec upon receiving folder on/off detecting signal indicating openness of the folder.

Preferably, the switch may disconnect the microphone and the audio codec upon receiving the folder on/off detecting signal indicating closure of the folder.

Differently, there is provided a method for processing voice in a mobile communication terminal comprising: disconnecting microphone and audio codec to block voice signal from the microphone, on connecting handsfree and the mobile communication terminal; maintaining call connection when the handsfree is disconnected from the mobile communication terminal; and maintaining status of disconnection between the microphone and audio codec until a folder of the mobile communication terminal is opened.

According to the present invention, in a folder-type mobile communication terminal, an analog switch is connected to a line for transmitting a folder on/off detecting signal to a main chip and to a microphone input line, so that the folder-on/off detecting signal is used as a switching control signal of the analog switch for controlling flow of the voice signal applied from the microphone of the mobile communication terminal. Particularly, blocking the voice signal applied from the microphone is maintained even though the handsfree is pulled out under a state that call connection is performed with the folder being closed and the handsfree being connected. Thus, howling and echo, which occurred in the related art, can be eliminated.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a configuration for processing voice in a conventional mobile communication terminal;

FIG. 2 is a block diagram illustrating a configuration for processing voice in a mobile communication terminal according to an embodiment of the present invention;

FIG. 3 is an exemplary circuit diagram of an analog switch illustrated in FIG. 2; and

FIG. 4 is a flow chart illustrating a method of processing voice in a mobile communication terminal according to an embodiment of the present invention.

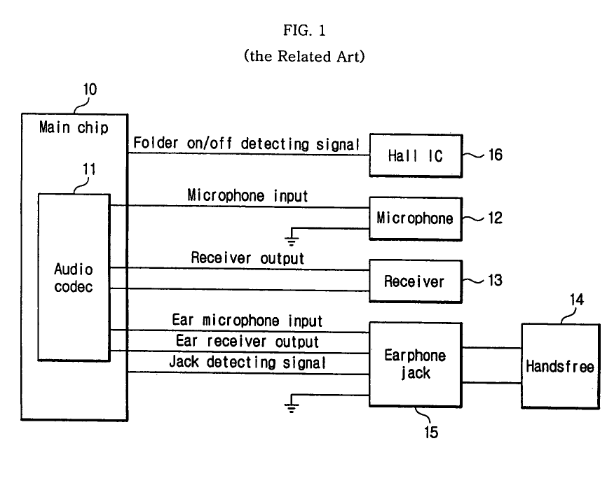

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

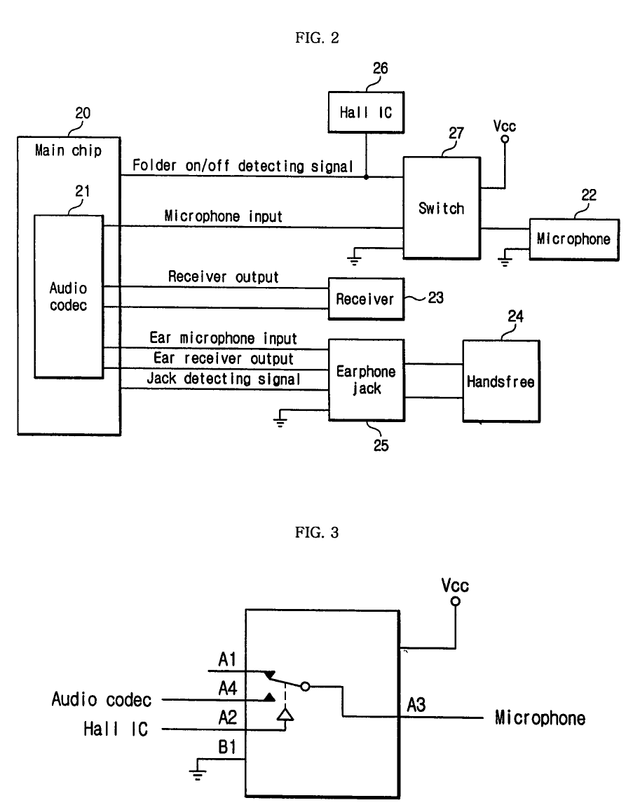

As illustrated in FIG. 2, a configuration for processing voice in a mobile communication terminal according to an embodiment of the present invention comprises: a main chip 20 for controlling an audio codec 21; a microphone 22 for inputting a voice signal to the audio codec; a receiver 23 for outputting the voice signal processed by the audio codec 21; a handsfree 24 having functions of inputting and outputting the voice; an earphone jack 25 for connecting the handsfree 24 to the mobile communication terminal; a hall IC 26 for detecting whether a folder of the mobile communication terminal is opened or closed; and a switch 27 for controlling flow of the voice signal applied from the microphone 22 to the audio codec 21 according to an folder on/off detecting signal applied from the hall IC 26.

The main chip 20 controls operations of all elements. Particularly, the main chip 20 checks whether the handsfree 24 is connected or not through the earphone jack 25 by receiving a jack detecting signal from the earphone jack 25, and checks whether the folder of the mobile communication terminal is opened or closed by receiving a folder on/off detecting signal from the hall IC 26.

The switch 27, an analog switch as illustrated in FIG. 3, is connected to a line for transmitting the folder on/off detecting signal applied from the hall IC 26 to the main chip 20, and to a microphone input line. The switch 27, located in between the audio codec 21 and the microphone 22, controls flow of the voice signal applied from the microphone 22 by using the folder on/off detecting signal applied from the hall IC 26 as a switching control signal. In particular, by maintaining a status of blocking the voice signal applied from the microphone even though the handsfree is pulled out during a call connection with the folder being closed and the handsfree being connected, howling and echo, which occurred in the related art, can be eliminated. Further, by immediately blocking the voice signal applied from the microphone when the main chip detects that the folder of the mobile communication terminal is closed during a call connection with the folder being opened, howling and echo, which occurred in the related art, can be eliminated.

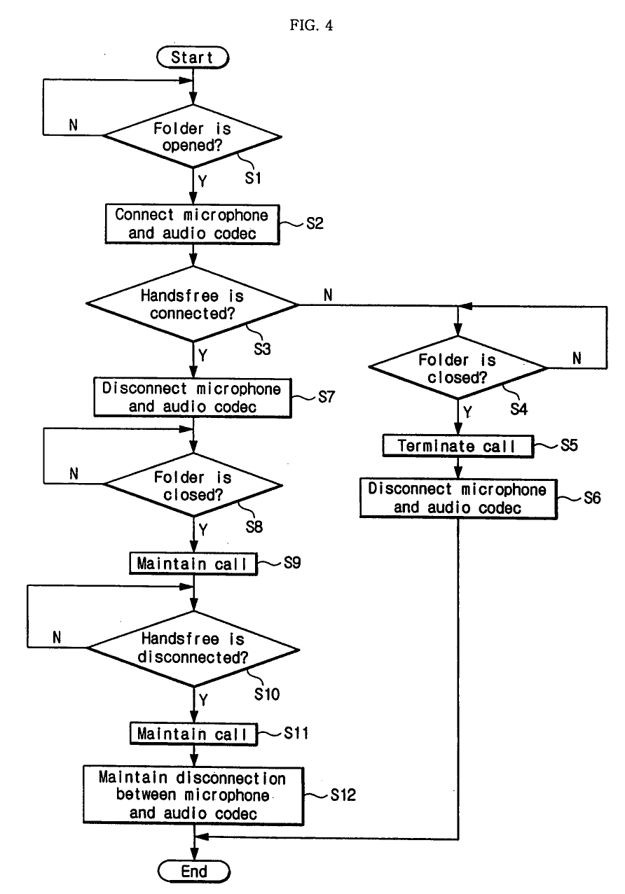

A method of processing a voice in a mobile communication terminal according to an embodiment of the prevent invention will now be described with reference to FIG. 4.

When connecting a call with a folder-type mobile communication terminal, the hall IC 26 checks whether the folder of the mobile communication terminal is closed or opened. The hall IC 26 generates a folder on/off detecting signal depending on the checking result and applies the generated signal to the main chip 20 and the switch 27.

Then, the main chip 20 checks whether the folder of the mobile communication terminal is closed or opened by checking the folder on/off detecting signal applied from the hall IC 26. The switch 27 has a voice signal applied from the microphone 22 flow to the audio codec 21 provided in the main chip 20, according to the folder on/off detecting signal applied from the hall IC 26.

In other words, when the folder is opened, the hall IC 26 generates a folder on/off detecting signal indicating openness of the folder (for example, ‘high’ level signal) and applies the generated signal to the main chip 20 and the switch 27. The main chip 20 and the switch 27 recognize that the folder is opened, by checking the folder on/off detecting signal indicating openness of the folder applied from the hall IC 26 (S1).

The switch 27 uses the folder on/off detecting signal indicating openness of the folder applied from the hall IC 26 as a switching control signal. The switch 27 connects a ‘A3’ terminal connected to the microphone 22 and a ‘A4’ terminal connected to the audio codec 21 based on the folder on/off detecting signal indicating openness of the folder and thus has the voice signal applied from the microphone 22 flow to the audio codec 21, so that the main chip 20 makes it possible to perform a call connection (S2).

Meanwhile, when connecting a call with the folder-type mobile communication terminal using the handsfree 24, a jack detecting signal is applied to the main chip 20 through the earphone jack 25, depending on the state that the handsfree 24 is connected to the mobile communication terminal through the earphone jack 25 or disconnected from the mobile communication terminal.

Thus, the main chip 20 checks whether the handsfree 24 is connected through the earphone jack 25 to the mobile communication terminal by checking the jack detecting signal applied from the earphone jack 25 (S3).

When the folder of the mobile communication terminal is closed in a state that the handsfree is not connected to the mobile communication terminal (i.e., there is no jack detecting signal applied from the earphone jack 25), the hall IC 26 generates a folder on/off detecting signal indicating closure of the folder (for example, ‘low’ level signal) and applies the generated signal to the main chip 20 and the switch 27.

At the moment, the main chip 20 recognizes that the folder is closed, by checking the folder on/off detecting signal indicating the closure of the folder applied from the hall IC 26 (S4) and performs a call terminating operation by recovering sources set up for a call connection (S5).

At the same time, the switch 27 uses the folder on/off detecting signal indicating the closure of the folder applied from the hall IC 26 as a switching control signal. The switch connects the ‘A3’ terminal connected to the microphone 22 to an opened ‘A1’ terminal by the folder on/off detecting signal indicating the closure of the folder and thus disconnects the connection between the audio codec 21 and the microphone 22 so as not to have the voice signal applied from the microphone 22 flow to the audio codec 21 (S6).

On the contrary, if the handsfree is connected to the mobile communication terminal, i.e., the main chip 20 controls the switch 27 to disconnect the connection between the microphone 22 and audio codec 21 (S7). In other words, the main chip 20 makes the switch 27 block the voice signal to the audio codec 21.

Then, when the folder is closed (S8), the hall IC 26 generates a folder on/off detecting signal indicating closure of the folder (for example, ‘low’ level signal) and applies the generated signal to the main chip 20 and the switch 27.

As a result, the main chip 20 and the switch 27 recognize that the folder is closed by checking the folder on/off detecting signal indicating closure of the folder applied from the hall IC 26.

At this time, the main chip 20 recognizes that the folder is closed under a state that the handsfree is connected, and thus maintains the sources set up for a call connection to continuously perform the call connection (S9). At this time, the switch maintains connection between the ‘A3’ terminal connected to the microphone 22 and an opened ‘A1’ terminal, based on the folder on/off detecting signal indicating the closure of the folder.

When the handsfree is disconnected from the mobile communication terminal under the state that the folder is closed (i.e., there is no jack detecting signal applied from the earphone jack 25) (S10), the main chip 20 continues to maintain the call connection even though there is no jack detecting signal applied from the earphone jack 25 (S11). The switch 27 continues to maintain the disconnection between the audio codec 21 and the microphone 22 (S12) until the folder is opened, so that it is possible to prevent howling and echo.

As described above, according to the present invention, the analog switch is connected to the microphone, and the voice signal applied from the microphone is continuously blocked while the folder of the mobile communication terminal is closed.

Accordingly, even though the handsfree is disconnected from the mobile communication terminal with the folder being closed during call connection, howling and echo can be removed.

While the present invention has been shown and described with reference to certain preferred embodiments thereof, it will be understood by those skilled in the art that various changes in form and details may be made therein without departing from the spirit and scope of the invention as defined by the appended claims.

1. An apparatus for processing voice in a mobile communication terminal comprising:
a main chip for controlling an audio codec;
a microphone for inputting a voice signal to the audio codec;
a receiver for outputting the voice signal processed by the audio codec;
a handsfree for performing functions of inputting and outputting the voice;
an earphone jack for connecting the handsfree to the audio codec;
a hall IC for generating folder on/off detecting signal by sensing whether the folder of the mobile communication terminal is opened or closed; and
a switch, located in between the microphone and the audio codec, for connecting the microphone and the audio codec based on the folder on/off detecting signal generated by the hall IC and jack detecting signal indicating that the handsfree is connected to the mobile communication terminal.

2. The apparatus according to claim 1, wherein the switch disconnects the microphone and the audio codec upon receiving the jack detecting signal.

3. The apparatus according to claim 2, wherein the switch maintains disconnection between the microphone and the audio codec without the jack detecting signal, while receiving the folder on/off detecting signal indicating closure of the folder.

4. The apparatus according to claim 3, wherein the switch reconnects the microphone and the audio codec upon receiving folder on/off detecting signal indicating openness of the folder.

5. The apparatus according to claim 1, wherein the switch disconnects the microphone and the audio codec upon receiving the folder on/off detecting signal indicating closure of the folder.

6. A method for processing voice in a mobile communication terminal comprising:
disconnecting microphone and audio codec to block voice signal from the microphone, on connecting handsfree and the mobile communication terminal;
maintaining call connection when the handsfree is disconnected from the mobile communication terminal; and
maintaining status of disconnection between the microphone and audio codec until a folder of the mobile communication terminal is opened.
